(19) United States
(12) Patent Application Publication
(10) Pub. No.: US 2026/0370166 A1
(43) Pub. Date: Nov. 19, 2026

(54) Control Method Based on ESMDO and Model-Free Adaptive Sliding Mode

(71) Applicant: Suzhou University of Science and Technology, Suzhou (CN)

(72) Inventors: Qixin Zhu, Suzhou (CN); Xuan Wu, Suzhou (CN); Hongli Liu, Suzhou (CN); Yehu Shen, Suzhou (CN); Fuzhou Niu, Suzhou (CN)

(73) Assignee: Suzhou University of Science and Technology, Suzhou (CN)

(21) Appl. No.: 19/413,119

(22) Filed: Dec. 9, 2025

(30) Foreign Application Priority Data
May 9, 2025 (CN) 202510598056.X

(51) Int. Cl. H02P 21/00; H02P 21/13

(52) U.S. Cl. CPC H02P 21/0007; H02P 21/13; H02P 2207/055

(57) ABSTRACT

A control method based on ESMDO and model-free adaptive sliding mode. A mathematical model of SPMSM is established to obtain the state equation of the speed loop. To construct a model-free adaptive sliding mode controller, establish an ultra-local model of the nonlinear system and introduce the state equation to obtain the extended ultra-local model of the speed loop of SPMSM. Based on the model-free control theory and the ultra-local model, the integral-differential sliding surface and the model-free adaptive sliding mode control law of the speed loop are constructed. Construct an extended sliding mode disturbance observer. A model-free adaptive sliding mode controller outputs a reference current to the motor module based on the reference speed. The motor module outputs the actual current and speed, while the extended sliding mode disturbance observer observes and outputs the system parametric uncertainties and unknown disturbances, which are fed into the model-free adaptive sliding mode controller.

### CROSS-REFERENCE TO RELATED APPLICATIONS

The present application is based on and claims priority from Chinese patent application No. 202510598056.X filed on May 9, 2025, the entire disclosure of which is incorporated herein by reference.

### TECHNICAL FIELD

The present disclosure relates to the technical field of motor control, and particularly relates to a control method based on an Extended Sliding Mode Disturbance Observer (ESMDO) and model-free adaptive sliding mode.

### BACKGROUND

Permanent Magnet Synchronous Motor (PMSM) has found widespread application in numerous industries such as electric vehicles, medical equipment, and aerospace, owing to its advantages of simple structure, high efficiency, low noise, and high reliability. Conventional PI control is frequently employed in PMSM systems due to its simple principle, favorable dynamic performance, and ease of implementation. However, the PMSM constitutes a multivariable, strongly coupled, and nonlinear system. Both parameter variations and external disturbances can adversely affect the control performance of PMSM systems. Consequently, conventional PI control struggles to ensure efficient, precise, and stable operation of the motor in high-performance applications.

With a long-term development of control theory, advanced control methods such as Model Reference Adaptive Control (MRAC), Robust Control, Predictive Control, and Sliding Mode Control (SMC) have been applied to Permanent Magnet Synchronous Motor (PMSM) systems. Among these, Sliding Mode Control (SMC) has garnered significant attention from researchers due to its strong robustness and relative insensitivity to system parameter variations.

In some existing literature, speed loop controllers utilizing integral time-varying sliding mode variable structure control have been disclosed to achieve precise motor speed regulation. Other studies have proposed combining exponential functions with segmented power functions to construct composite reaching laws, thereby accelerating the system response speed. However, these approaches often require excessively high controller gains, which may compromise system stability. Furthermore, a fundamental challenge of sliding mode control is the chattering phenomenon caused by its discontinuous control action. Consequently, a critical objective in constructing sliding mode controllers is the effective mitigation of chattering.

Building upon the aforementioned schemes, further improvements have been proposed. One approach introduces an exponential term into the power reaching law while simultaneously incorporating system state variables into the power term exponent. This modification not only enhances the sliding mode reaching speed but also suppresses system chattering. Alternatively, some literature discloses a disturbance observer-based adaptive fuzzy sliding mode control method. This technique effectively reduces tracking error, mitigates chattering, and improves overall system control performance.

However, the aforementioned control algorithms are all model-based methods whose performance depends on accurate modeling of the controlled object. During actual operation, motor parameters do not remain constant, which imposes limitations on the effectiveness of these algorithms. Consequently, the construct of a controller that does not rely on a specific model and possesses strong robustness is of significant importance for achieving high-precision and fast-response performance.

### SUMMARY OF THE INVENTION

The disclosure provides a control method based on an Extended Sliding Mode Disturbance Observer (ESMDO) and a model-free adaptive sliding mode, which effectively enhances the motor system's capability to reject disturbances and improves its overall robustness.

The present disclosure provides a control method based on ESMDO and model-free adaptive sliding mode control, comprising: establishing an Surface-mounted Permanent Magnet Synchronous Motor mathematical model to obtain a state equation of speed loop; constructing a model-free adaptive sliding mode controller, which further comprising: first establishing an ultra-local model for a single-input single-output nonlinear system, and introducing the state equation of the speed loop to obtain an extended ultra-local model of the SPMSM speed loop; based on model-free control theory and integrating the extended ultra-local model of the SPMSM speed loop, constructing an integral-derivative sliding mode surface and a model-free adaptive sliding mode control law for the speed loop; constructing an Extended Sliding Mode Disturbance Observer, establishing a disturbance observer model and constructing a sliding mode control law for the observer based on the extended ultra-local model of the SPMSM speed loop; the model-free adaptive sliding mode controller outputs a reference current to the motor module based on the input reference speed, the motor module outputs the actual current and actual speed, the Extended Sliding Mode Disturbance Observer observes and outputs the system parametric uncertainties and unknown disturbances, which are subsequently fed back into the model-free adaptive sliding mode controller, the actual speed is also utilized for feedforward compensation of the reference speed, thereby achieving comprehensive control of the motor module.

Furthermore, in establishing the SPMSM mathematical model, the core saturation effects are ignored, the eddy current and hysteresis losses are ignored, and internal parameter perturbation and load disturbance are introduced to obtain the motor's torque equation and mechanical motion equation, and the state equation of the speed loop is obtained based on the torque equation and mechanical motion equation.

Furthermore, the torque equation of the motor is:

$${T}_{e} = \frac{3}{2} {n}_{p} {i}_{q} {ψ}_{f} + Δ {T}_{e} ,$$

where Tₑ is the electromagnetic torque, i_{q} is the q-axis stator current component, nₚ is the number of pole pairs, ψ_{f} is the permanent magnet flux linkage, and ΔTₑ is the variation of the electromagnetic torque; the mechanical motion equation of the motor is:

$$\frac{d {ω}_{e}}{dt} = \frac{{n}_{p}}{J} ( {T}_{e} - {T}_{L} - B {ω}_{m} ) + Δ {P}_{n} ,$$

where T_{L} is the load torque, B is the viscous friction coefficient, ωₘ is the mechanical angular velocity, ωₑ is the electrical angular velocity, ΔPₙ is the disturbance variable caused by variations in the moment of inertia and viscous friction coefficient,

$$\frac{d {ω}_{e}}{dt}$$

represents the differential of the electrical angular inertia and viscous friction coefficient, velocity, J is the moment of inertia; the state equation of the motor's speed loop is:

$$\frac{d {ω}_{e}}{dt} = \frac{3}{2} \frac{{n}_{p}^{2}}{J} {ψ}_{f} - \frac{B}{J} {ω}_{e} + \frac{{n}_{p}}{J} ( Δ {T}_{e} - {T}_{L} + Δ {T}_{L} ) + Δ {P}_{n} ,$$

where ΔT_{L} is the unknown disturbance caused by variations of the load torque.

Further, the ultra-local model of the nonlinear system is:

$$\{ \begin{matrix}\dot{x} = {α}_{1} u + {β}_{1} x + {F}_{1} \\ y = x\end{matrix} ,$$

where α₁ is a design parameter to be determined, β₁ is the state gain of the system, F₁ is a nonlinear bounded function satisfying the Lebesgue measurability theorem, and u is the system input variable, and X is the input variable of nonlinear system.

Further, the extended ultra-local model of the SPMSM speed loop is:

$$\{ \begin{matrix}\frac{d {ω}_{e}}{dt} = α {i}_{q} + {βω}_{e} + F \\ \frac{dF}{dt} = ξ ( t )\end{matrix} ,$$

Where α is the q-axis current gain to be determined, β is the speed gain to be determined, F is system parametric uncertainties and unknown disturbances, ξ(t) is the rate of change of F and i_{q} is the q-axis stator current component.

Further, the integral differential sliding mode surface is defined as: s=x₁+c∫x₁+m\dot{x}₁, where x₁ is the speed error, both c and m are constants greater than zero.

Further, an adaptive exponential reaching law is constructed based on the integral differential sliding mode surface, and the said adaptive exponential reaching law is expressed as follows:

$$\{ \begin{matrix}\dot{s} = - η sigmoid ( s ) - ks \\ \dot{\hat{η}} = \vert s \vert\end{matrix} ,$$

where

$$sigmoid ( x ) = \frac{2}{1 + {e}^{- ax}} - 1 ,$$

a>0, η is an adaptive factor, and k is an arbitrary positive real number.

Further, the model-free adaptive sliding mode control law for the speed loop is:

$${i}_{q}^{*} = \frac{- \hat{F} - {βω}_{e} + {\dot{ω}}_{e}^{*} + ks + \hat{η} sigmoid ( s ) + c ( {ω}_{e}^{*} - {ω}_{e} ) + m ( {\ddot{ω}}_{e}^{*} - {\ddot{ω}}_{e} )}{α} ,$$

where \hat{F} is the online estimation of F using the Extended Sliding Mode Disturbance Observer (ESMDO),

$${ω}_{e}^{*}$$

is the reference speed of the motor, ωₑ is the electrical angular velocity, and α is a q-axis current coefficient to be determined.

Further, the disturbance observer model is defined as:

$$\{ \begin{matrix}\frac{d {\hat{ω}}_{e}}{dt} = α {i}_{q} + β {\hat{ω}}_{e} + \hat{F} + {u}_{ESMDO} \\ \frac{d \hat{F}}{dt} = χ \cdot {u}_{ESMDO}\end{matrix} ,$$

where, \hat{ω}ₑ is the observed speed value, \hat{F} is the observed value of system parameter uncertainties and unknown disturbances, d\hat{F}/dt is the rate of change of \hat{F}, χ is the gain of the disturbance observer, and u_{ESMDO} is the observer sliding mode control law.

Further, an error equation is obtained based on the disturbance observer model and the SPMSM speed loop extended ultra-local model, as follows:

$$\{ \begin{matrix}{\dot{e}}_{s} = β {e}_{s} + {e}_{f} + {u}_{ESMDO} \\ {\dot{e}}_{f} = χ \cdot {u}_{ESMDO} - ξ ( t )\end{matrix} ,$$

where eₛ is the speed observation error, defined as eₛ=\hat{ω}ₑ−ωₑ, e_{f} is the observation error of F, defined as e_{f}=\hat{F}−F; the observer sliding mode surface is constructed as: s_{ω}=eₛ=\hat{ω}ₑ−ωₑ; the observer exponential reaching law is constructed as: \dot{s}_{ω}=−ε_{ω} sgn(eₛ)−k_{ω}eₛ, where ε_{ω} is a switch gain to be constructed, k_{ω} is an exponential term coefficient to be constructed, and both ε_{ω} and k_{ω} are greater than zero, based on the error equation and the observer exponential reaching law, the observer sliding mode control law u_{ESMDO} is obtained as: u_{ESMDO}=ε_{ω} sigmoid(eₛ)−k_{ω}eₛ−βeₛ.

### BRIEF DESCRIPTION OF THE DRAWINGS

FIG. 1 is a block diagram of the model-free adaptive sliding mode algorithm of the present disclosure.

FIG. 2 is a comparison diagram of the sgn function and the sigmoid function.

FIG. 3 illustrates convergence patterns of the sigmoid function under different values of parameter ‘a’ in the present disclosure.

FIG. 4 is a structural block diagram of the SPMSM system according to the present disclosure.

FIG. 5 is a simulation graph of the speed curve during no-load startup in the present disclosure.

FIG. 6 is a simulation graph of the speed curve during a sudden load increase in the present disclosure.

FIG. 7 is a simulation graph of the speed curve during a sudden load decrease in the present disclosure.

FIG. 8 is a simulation graph of the speed curve during speed acceleration and deceleration in the present disclosure.

FIG. 9 is a simulation graph of the speed curve during forward and reverse rotation in the present disclosure.

### DETAILED DESCRIPTION OF EMBODIMENTS

The following describes the present disclosure in further detail with reference to the accompanying drawings and specific embodiments, to enable those skilled in the art to better understand and implement the disclosure. However, the provided examples shall not be construed as limiting the scope of the disclosure.

The permanent magnet synchronous motor (PMSM) module is a mechatronic unit highly integrated by the motor body, drive control unit, and sensor feedback unit. Its main components are introduced below. The motor body includes a stator and a rotor, wherein the stator includes a stator core and a three-phase armature winding, which generates a rotating magnetic field after being energized. The rotor is embedded with high-performance permanent magnets (such as Nd. Fe, B) to establish a constant magnetic field. According to the installation position of permanent magnets, the permanent magnet synchronous motors are mainly divided into surface-mounted permanent magnet synchronous motors and built-in permanent magnet synchronous motors. The drive control unit includes a controller (MCU/DSP), a power inverter, a drive circuit and a power supply. The controller runs core algorithms such as vector control and processes instructions and feedback. The power inverter converts direct current into three-phase alternating current with controllable frequency and amplitude to drive the motor. The drive circuit and the power supply provide isolation, amplification and protection, and provide stable voltage for each circuit. The sensing and feedback unit includes a position/speed sensor, a current sensor, and a temperature sensor. Among them, the position/speed sensor detects the rotor position and speed in real time, which is the key to achieve precise closed-loop control. Encoders or resolvers are often used. Current sensors detect phase currents for current loop closed loop control and overload protection. Temperature sensors monitor motor winding and controller temperatures to achieve overheating protection. In addition, the permanent magnet synchronous motor (PMSM) module also includes mechanical and auxiliary structures, including the housing and cover, the cooling system, and the electrical interface. Among them, the housing and cover provide structural support, protection level (such as IP54) and heat dissipation paths. The cooling system ensures that the module temperature is within a safe range by air cooling (heat sink fins/fans) or liquid cooling (cooling runners). The electrical interface uses integrated connectors for power supply, communication and signal transmission.

With reference to FIG. 1, which shows an embodiment of the control method based on the ESMDO and model-free adaptive sliding mode: a Surface-mounted Permanent Magnet Synchronous Motor (SPMSM, hereinafter referred to as the motor) is a multi-variable, strongly coupled, and nonlinear complex system. When the motor system is affected by uncertainties such as load disturbances, issues including speed fluctuations and instability may arise. The present disclosure can effectively address these issues, enhancing the anti-interference capability and robustness of the motor system.

Specifically, firstly in establishing the mathematical model of the SPMSM, which describes the internal laws of the motor body (stator, rotor, permanent magnet) in circuit and mechanics, the core saturation effects are neglected, and eddy current as well as hysteresis losses are disregarded. The stator voltage equations in the d-q rotating coordinate system are expressed as:

$$\{ \begin{matrix}{u}_{d} = {R}_{s} {i}_{d} + {L}_{d} \frac{{di}_{d}}{dt} - {ω}_{e} {L}_{q} {i}_{q} \\ {u}_{q} = {R}_{s} {i}_{q} + {L}_{q} \frac{{di}_{q}}{dt} + {ω}_{e} {L}_{d} {i}_{d} + {ω}_{e} {ψ}_{f}\end{matrix} \qquad ( 1 )$$

where, u_{d}, u_{q} are the d-axis and q-axis stator voltage component respectively, Rₛ is the stator resistance, L_{d}, L_{q} are the d-axis and q-axis stator inductance component respectively, wherein for a surface-mounted permanent magnet synchronous motor, L_{d}=L_{q}, i_{d}, i_{q} are d-axis and q-axis stator current component respectively, ωₑ is electrical angular velocity, ψ_{f} is permanent magnet flux linkage.

The above stator voltage equation corresponds to the resistance and inductance characteristics of the three-phase winding of the stator, and the back electromotive force induced in the winding when the rotor permanent magnet rotates.

At this point, the torque equation of the surface-mounted permanent magnet synchronous motor is expressed as:

$${T}_{e} = \frac{3}{2} {n}_{p} {i}_{q} {ψ}_{f} \qquad ( 2 )$$

Where Tₑ is the electromagnetic torque, nₚ is the number of pole pairs.

The above torque equation of the motor describes the physical process of torque generated by the interaction between the stator current and the rotor permanent magnet magnetic field.

The mechanical motion equation of the motor is expressed as:

$$\frac{d {ω}_{e}}{dt} = \frac{{n}_{p}}{J} ( {T}_{e} - {T}_{L} - B {ω}_{m} ) \qquad ( 3 )$$

Where T_{L} is the load torque, B is the viscous friction coefficient, ωₘ is the mechanical angular velocity.

The above mechanical motion equation describes the Newtonian mechanical process of generating electromagnetic torque, overcoming load torque (connected external mechanical device) and friction torque (bearing, wind resistance), driving the rotor and load inertia to accelerate or decelerate.

However, during practical operation, the SPMSM is subject to internal parameter perturbations and load. Under these conditions, the stator voltage equations in the d-q rotating coordinate system is:

$$\{ \begin{matrix}{u}_{d} = {R}_{s} {i}_{d} + {L}_{d} \frac{{di}_{d}}{dt} - {ω}_{e} {L}_{q} {i}_{q} + Δ {u}_{d} \\ {u}_{q} = {R}_{s} {i}_{q} + {L}_{q} \frac{{di}_{q}}{dt} + {ω}_{e} {L}_{d} {i}_{d} + {ω}_{e} {ψ}_{f} + Δ {u}_{q}\end{matrix} \qquad ( 4 )$$

where Δu_{d} and Δu_{q} represent variations in the d-axis and q-axis stator voltages respectively caused by motor parameter perturbations, as shown in Equation (5):

$$\{ \begin{matrix}Δ {u}_{d} = Δ {R}_{s} {i}_{d} + Δ {L}_{d} \frac{{di}_{d}}{dt} - {ω}_{e} Δ {L}_{q} {i}_{q} \\ Δ {u}_{q} = Δ {R}_{s} {i}_{q} + Δ {L}_{q} \frac{{di}_{q}}{dt} + {ω}_{e} Δ {L}_{d} {i}_{d} + {ω}_{e} Δ {ψ}_{f}\end{matrix} \qquad ( 5 )$$

Where ΔRₛ is the variation of the stator resistance Rₛ, ΔL_{d}, ΔL_{q} are the variations of the d-axis and q-axis inductances, Δψ_{f} is the variation of the permanent magnet flux linkage.

Taking into account the effects of internal parameter perturbations and load disturbances, the torque equation of the motor is constructed as:

$${T}_{e} = \frac{3}{2} {n}_{p} {i}_{q} {ψ}_{f} + Δ {T}_{e} \qquad ( 6 )$$

where ΔTₑ is the variation of the electromagnetic torque. Under these conditions, the mechanical motion equation of the motor is expressed as:

$$\frac{d {ω}_{e}}{dt} = \frac{{n}_{p}}{J} ( {T}_{e} - {T}_{L} - B {ω}_{m} ) + Δ {P}_{n} \qquad ( 7 )$$

where ΔPₙ is the disturbance variable caused by variations in the moment of inertia and viscous friction coefficient.

By combining Equations (6) and (7), the state equation for the speed loop can be derived as:

$$\frac{d {ω}_{e}}{dt} = \frac{3}{2} \frac{{n}_{p}^{2}}{J} {ψ}_{f} - \frac{B}{J} {ω}_{e} + \frac{{n}_{p}}{J} ( Δ {T}_{e} - {T}_{L} + Δ {T}_{L} ) + Δ {P}_{n} \qquad ( 8 )$$

Where ΔT_{L} is an unknown disturbance caused by variations in the load torque.

The state equation for the speed loop is a dynamic description of the “rotor-load” mechanical system, which is derived from the mechanical motion part of the SPMSM mathematical model and specifically for the speed control loop.

Subsequently, a model-free adaptive sliding mode controller is constructed. The block diagram of the model-free adaptive sliding mode algorithm proposed in this application is shown in FIG. 1. In the diagram, the feedback controller is an adaptive sliding mode controller, uₑ is the output of the controller, and the Extended Sliding Mode Disturbance Observer (ESMDO) observes and estimates the aggregated system uncertainties and unknown disturbances, denoted as F.

Specifically, the ultra-local model for the speed loop is first established. The ultra-local model for a single-input, single-output (SISO) nonlinear system is expressed as:

$$\{ \begin{matrix}{y}^{( n )} = g ( x ) + bu \\ y = x\end{matrix} \qquad ( 9 )$$

Where y represents the system output, n denotes the order of differentiation, and n≥1, g(x) is an unknown nonlinear function dependent solely on x, and satisfying the boundedness condition of a Lipschitz function, b represents a nonzero constant parameter, u denotes the system input.

The ultra-local model of the above nonlinear system is based on the idea of model-free control, and the ultra-local model is used to describe the nonlinear system.

By combining Equations (8) and (9), the typical ultra-local model for the SPMSM speed loop is obtained as:

$$\frac{d {ω}_{e}}{dt} = {α}_{1} {i}_{q} + g \qquad ( 10 )$$

Where α₁ is a design parameter to be determined, g is the motor parameter uncertainties and unknown disturbances.

According to the novel ultra-local model theory, g in Equation (10) is equivalent to g(x), denoting the motor parameter uncertainties and unknown disturbances. This term can be further decomposed into two components: a linear system state and a nonlinear disturbance part, specifically as shown in Equation (11):

g(x)=β₁x+F (11)

Where βᵢ is the state gain of the system, F₁ is a nonlinear bounded function satisfying Lebesgue measurability theorem.

Substituting Equation (11) into Equation (9) yields the novel ultra-local model for the nonlinear system as:

$$\{ \begin{matrix}\dot{x} = {α}_{1} u + {β}_{1} x + {F}_{1} \\ y = x\end{matrix} \qquad ( 12 )$$

Based on the SPMSM speed loop state equation (8) and the ultra-local model (12), an extended novel ultra-local model specifically for the speed loop is constructed as follows:

$$\{ \begin{matrix}\frac{d {ω}_{e}}{dt} = α {i}_{q} + {βω}_{e} + F \\ \frac{d F}{dt} = ξ ( t )\end{matrix} \qquad ( 13 )$$

where α is the q-axis current gain to be determined, β is the speed gain to be determined, F is system parameter uncertainties and unknown disturbances, and ξ(t) is the rate of change of F.

The above extended ultra-local mode of SPMSM speed loop is a ultra-local model of input and output and velocity loop in PMSM system according to the idea of model-free control and ultra-local model.

### Construct of the Model-Free Adaptive Sliding Mode Controller:

Based on model-free control theory and combined with the SPMSM speed loop ultra-local model of Equation (13), when n=1, the model-free control law for the speed loop is constructed as:

$${i}_{q}^{*} = \frac{- F - {βω}_{e} + {\dot{ω}}_{e}^{*} + {u}_{c}}{α} \qquad ( 14 )$$

Where

$${i}_{q}^{*}$$

is the predetermined q-axis current component,

$${ω}_{e}^{*}$$

is the reference motor speed, uₑ is the output of the feedback controller.

The reference speed value and the actual value are selected as the state variables of the controller, while introducing the state variables x₁ and x₂:

$$\{ \begin{matrix}{x}_{1} = {ω}_{e}^{*} - {ω}_{e} \\ {x}_{2} = \int {x}_{1} = \int {ω}_{e}^{*} - {ω}_{e}\end{matrix} \qquad ( 15 )$$

By combining Equations (13) and (14) gives:

$${u}_{c} = {\dot{ω}}_{e} - {\dot{ω}}_{e}^{*} \qquad ( 16 )$$

Taking the derivative of Equation (15) and combining it with Equation (16) yields:

$$\{ \begin{matrix}{x}_{1} = {\dot{ω}}_{e}^{*} - {\dot{ω}}_{e} = - {u}_{c} \\ {x}_{2} = {x}_{2} = {ω}_{e}^{*} - {ω}_{e}\end{matrix} \qquad ( 17 )$$

To reduce the steady-state error, an integral-differential sliding mode surface with the independent variable x₁ is selected:

s=x₁+c∫x₁+m\dot{x} (18)
where both c and m are constants greater than zero.

Taking the derivative of Equation (18) and substituting Equation (17) gives:

$$\begin{matrix}\dot{s} = {\dot{x}}_{1} + c {x}_{1} + m {\ddot{x}}_{1} \\ = c {x}_{1} - {u}_{c} + m {\ddot{x}}_{1}\end{matrix} \qquad ( 19 )$$

The mathematical expression of the traditional exponential reaching law (ERL) is shown in Equation (20):

\dot{s}=−ε sgn(s)−ks (20)
where ε and k are positive real numbers.

As evident from the above equation, the traditional exponential reaching law approaches the sliding mode surface at a constant speed when far from the surface. This results in the following issues: when ε is too small, the approach speed decreases, the approach time lengthens, and consequently the adjustment time increases; conversely, when ε is too large, the approach speed accelerates, the approach time shortens, and the adjustment time reduces, but the excessive velocity upon reaching the sliding mode surface induces significant chattering, thereby compromising system stability. To address these challenges, an adaptive exponential reaching law is constructed as shown in Equation (21):

$$\{ \begin{matrix}\dot{s} = - ηsigmoid ( s ) - k s \\ \dot{\hat{η}} = \vert s \vert\end{matrix} \qquad ( 21 )$$

Where

$$sigmoid ( x ) = \frac{2}{1 + {e}^{- ax}} , a > {0}_{o}$$

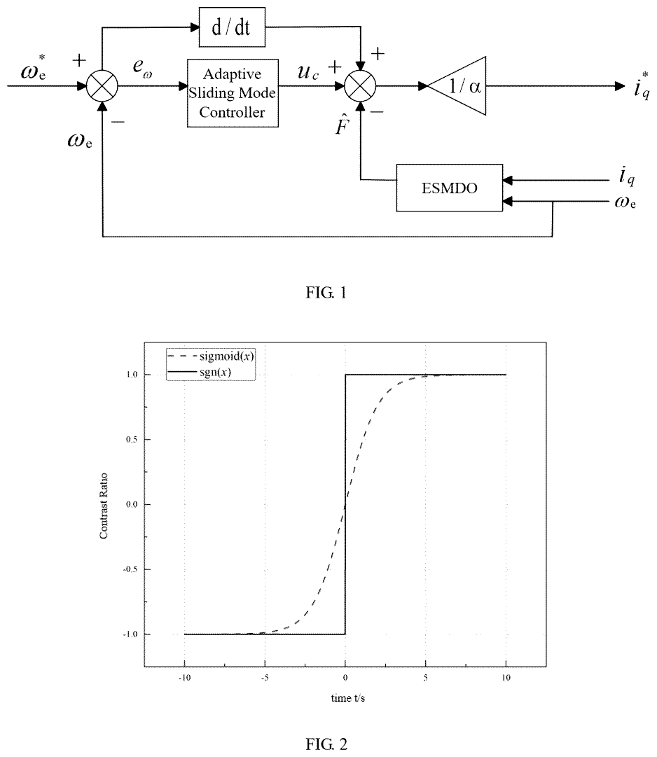

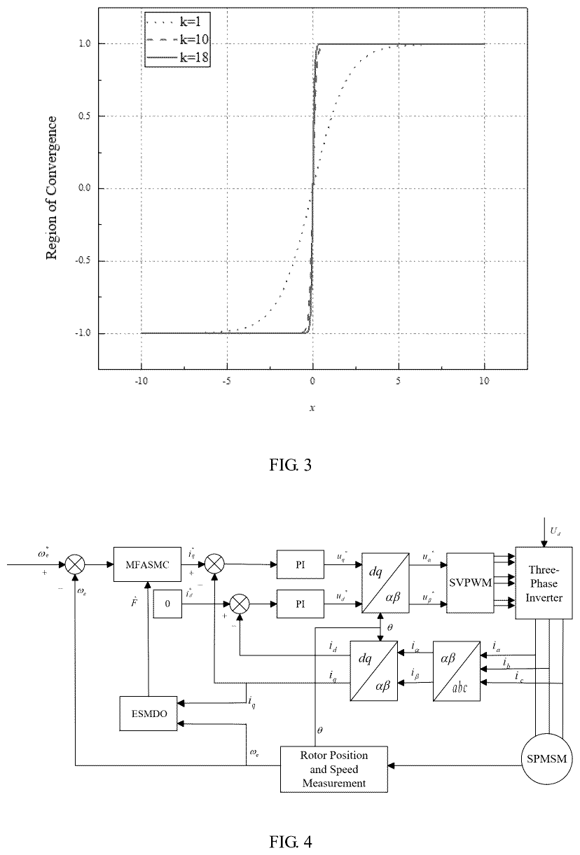

Due to the discontinuous nature of the sgn(x) function, which is prone to inducing chattering, the present disclosure selects the sigmoid(x) function to replace the original switching function sgn(x). A comparative graph of the two functions is shown in FIG. 2, while FIG. 3 illustrates the convergence behavior of the sigmoid function under different values of a.

As can be observed from FIGS. 2 and 3, the sigmoid function converges within the interval [−1, 1], and its convergence speed depends on the value of a. When a>1, the sigmoid function is monotonically increasing. The convergence speed of the sigmoid function accelerates as the value of a increases, leading to a faster system response. However, if the value of a is excessively large, the sigmoid function approximates the sgn function, thereby increasing chattering. Conversely, if the value of a is too small, although the curve becomes smoother and system robustness improves, the system response slows down, resulting in degraded dynamic performance.

To ensure satisfactory system convergence speed while effectively reducing chattering, an appropriate value of a must be selected. In this application, the value of a is chosen as 18.

From Equations (19) and (21), the feedback controller c_{c} is obtained as:

u_{c}=ks+\hat{η}sigmoid(s)+cx₁+m\ddot{x}₁ (22)

Combining Equations (14) and (22) yields the model-free adaptive sliding mode control law for the speed loop:

$${i}_{q}^{*} = \frac{\begin{matrix}- \hat{F} - {βω}_{e} + {\dot{ω}}_{e}^{*} + ks + \hat{η} sigmoid ( s ) + \\ c ( {ω}_{e}^{*} - {ω}_{e} ) + m ( {\ddot{ω}}_{e}^{*} - {\ddot{ω}}_{e} )\end{matrix}}{α} \qquad ( 23 )$$

where \dot{F} is the online estimation of F using the Extended Sliding Mode Disturbance Observer (ESMDO).

### Stability Proof:

The Lyapunov function V1 is selected as:

$${V}_{1} = \frac{1}{2} {s}^{2} \qquad ( 24 )$$

Taking the derivative of Equation (24) gives:

\dot{V}₁=s\dot{s} (25)

Substituting Equation (21) into Equation (25) results in:

$$\begin{matrix}{\dot{V}}_{1} = s [ - sigmoid ( s ) \int \vert s \vert dt - ks ] \\ = - sigmoid ( s ) \times s \times \int \vert s \vert dt - k {s}^{2} \\ \leq 0\end{matrix} \qquad ( 26 )$$

According to Lyapunov stability theory, the system employing the model-free adaptive sliding mode controller is asymptotically stable.

Subsequently, an Extended Sliding Mode Disturbance Observer (ESMDO) is constructed:

To enhance the rapid response capability and estimation accuracy of the disturbance observer, the present disclosure employs an Extended Sliding Mode Disturbance Observer (ESMDO). This observer extends the parameter uncertainties and unknown disturbances F existing in the system input as state variables and provides accurate estimation thereof.

Based on the extended ultra-local model of the speed loop described by Equation (13), the disturbance observer model is established as:

$$\{ \begin{matrix}\frac{d {\hat{ω}}_{e}}{d t} = α {i}_{q} + β {\hat{ω}}_{e} + \hat{F} + {u}_{ESMDO} \\ \frac{d \hat{F}}{d t} = χ \cdot {u}_{ESMDO}\end{matrix} \qquad ( 27 )$$

Where, \hat{ω}ₑ is the observed speed value, \hat{F} is the observed value of the system parameter uncertainties and unknown disturbances, d\hat{F}/dt is the rate of change of \hat{F}, χ is the gain of the disturbance observer, u_{ESMDO} is the sliding mode control law.

The combination of Equations (13) and (27) produces the error equation:

$$\{ \begin{matrix}{\dot{e}}_{s} = β {e}_{s} + {e}_{f} + {u}_{ESMDO} \\ {\dot{e}}_{f} = χ \cdot {u}_{ESMDO} - ξ ( t )\end{matrix} \qquad ( 28 )$$

Where eₛ is the speed observation error, defined as eₛ=\hat{ω}ₑ−ωₑ, e_{f} is the observation error of F, defined as e_{f}=\hat{F}−F.

The following observer sliding mode surface is selected:

s_{ω}=eₛ=\hat{ω}ₑ−ωₑ (29)

The observer exponential reaching law is chosen as:

$${\dot{s}}_{ω} = - {ε}_{ω} sgn ( {e}_{s} ) - {k}_{ω} {e}_{s} \qquad ( 30 )$$

Where ε_{ω} is a switch gain to be constructed, k_{ω} is an exponential term coefficient to be constructed, ε_{ω} and k_{ω} are greater than zero.

Combining Equations (28) and (30), the sliding mode control law u_{ESMDO} is derived as:

$${U}_{ESMDO} = - {ε}_{ω} sgn ( {e}_{s} ) - {k}_{ω} {e}_{s} - β {e}_{s} \qquad ( 31 )$$

### Stability Proof:

The Lyapunov function is V2 selected as:

$${V}_{2} = \frac{1}{2} {s}^{2} \qquad ( 32 )$$

Taking the derivative of V2 gives:

\dot{V}₂=s_{ω}s_{ω} (33)

Substituting Equation (28) into Equation (33) gives:

$$\begin{matrix}{\dot{V}}_{2} = {s}_{ω} {\dot{s}}_{ω} \\ = {e}_{s} ( β {e}_{s} + {e}_{f} + {u}_{ESMDO} ) \\ = {e}_{s} ( - {ε}_{ω} sgn ( {e}_{s} ) + {e}_{f} - {k}_{ω} {e}_{s} ) \\ = {e}_{s} {e}_{f} - {e}_{s} {ε}_{ω} sgn ( {e}_{s} ) - {k}_{ω} {e}_{s}^{2} \\ ⩽ {e}_{s} {e}_{f} - {e}_{s} {ε}_{ω} sgn ( {e}_{s} ) \\ ⩽ \vert {e}_{s} \vert ( \vert {e}_{f} \vert - {ε}_{ω} )\end{matrix} \qquad ( 34 )$$

Equation (34) satisfies ε_{ω}≥|e_{f}|, hence \dot{V}₂≤0, the observer is asymptotically stable, and the system states can reach the sliding surface within finite time. According to the sliding mode equivalent principle, eₛ=ėₛ=0, substituting this into Equation (28) yields:

$$\{ \begin{matrix}{e}_{f} = - {u}_{ESMDO} \\ {\dot{e}}_{f} = χ \cdot {u}_{ESMDO} - ξ ( t )\end{matrix} \qquad ( 35 )$$

Solving Equation (35) gives: e_{f}=e^{-χt}[∫ζ(t) e^{χt}dt+C] (36)
where C>0, the magnitude of χ affects the convergence speed of the system error.

To mitigate chattering in the Extended Sliding Mode Disturbance Observer (ESMDO), the sigmoid function is similarly employed to replace the sgn function. Consequently, the final sliding mode control law u_{ESMDO} becomes:

u_{ESMDO}=−ε_{ω}sigmoid(eₛ)−k_{ω}eₛ−βeₛ.

The model-free adaptive sliding mode controller and the Extended Sliding Mode Disturbance Observer (ESMDO) are implemented in the motor module to achieve effective control. Specifically, the model-free adaptive sliding mode controller outputs a reference current to the motor module based on the input reference speed, the motor module outputs the actual current and actual speed, The Extended Sliding Mode Disturbance Observer (ESMDO) observes the actual speed, the system parameter uncertainties and unknown disturbances, and outputs the actual speed, the system parameter uncertainties and unknown disturbances, the system parameter uncertainties and unknown disturbances are subsequently fed back to the model-free adaptive sliding mode controller. Furthermore, the actual speed is utilized to provide feedforward compensation to the reference speed.

The above-described the control method based on ESMDO and model-free adaptive sliding mode is executed by a computer, and the above-described model is built into and implemented by a controller of the computer.

### Simulation Verification and Analysis

A simulation model of the algorithm for model-free adaptive sliding mode control based on the Extended Sliding Mode Disturbance Observer (ESMDO) was constructed in Simulink. The implemented control strategy is i_{d}*=0, and the system block diagram is shown in FIG. 4. To verify the effectiveness of the proposed method, simulations were conducted comparing the approach presented in this application with both PI control and model-free sliding mode control (MFSMC). The motor parameters used in the experiment are listed in Table 1, while Table 2 details the controller parameters for the PI, MFSMC, and MFASMC+ESMDO controllers.

TABLE 1
SPMSM Parameters

| SPMSM Parameters | Unit | Value |
|---|---|---|
| Stator Winding Phase Resistance Rₛ | Ω | 0.96 |
| Number of Pole Pairs nₚ | Pairs | 4 |
| q-axis Stator Inductance L_{q} | H | 0.00525 |
| d-axis Stator Inductance L_{d} | H | 0.00525 |
| Rotor Flux Linkage Ψᵣ | W_{b} | 0.1827 |
| Moment of Inertia J | kg · m² | 0.003 |
| viscous friction coefficient B | N · m · s/rad | 0.008 |

TABLE 2
Control System Parameters

| PI | MFSMC + SMO | MFASMC + ESMDO |
|---|---|---|
| Kₚ = 0.14 | h = 10 | k = 810 |
| K_{I} = 7 | ε₁ = 0.01 | c = 0.45 |
| — | ε₂ = 110 | m = 0.00001 |
| — | — | a = 18 |
| — | — | χ = 12000 |

### Load Variation Simulation:

The total simulation time is set to 1 second, with a given speed of 400 r/min. The motor starts under no-load conditions. A step load torque of 10 N·m is abruptly applied at t=0.4 s and subsequently removed (reduced to 0) at t=0.6 s. FIG. 5 shows the speed response curves of the three control methods during the no-load startup process. Table 3 provides a detailed performance comparison of these three control methods under these conditions.

TABLE 3
Performance Comparison of the Three Control
Methods during No-Load Startup

| | | MFSMC + | MFASMC + |
|---|---|---|---|
| Performance Indicators | PI | SMO | ESMDO |
| Overshoot(r/min) | 37.244 | 0 | 0 |
| Adjustment Time(t/s) | 0.08 | 0.05 | 0.009 |
| Maximum | 2.435 | 0.482 | 0.341 |
| Steady-state Speed | | | |
| Fluctuation(r/min) | | | |

Note 1:
The adjustment time in Table 3 is defined as the time required for the absolute value of the difference between the given speed and the actual speed to converge within 1 r/min.

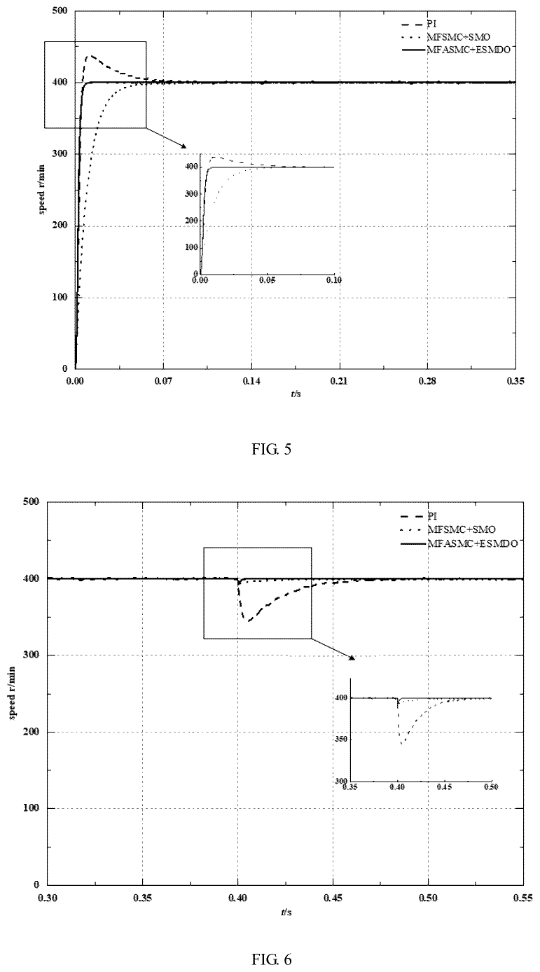

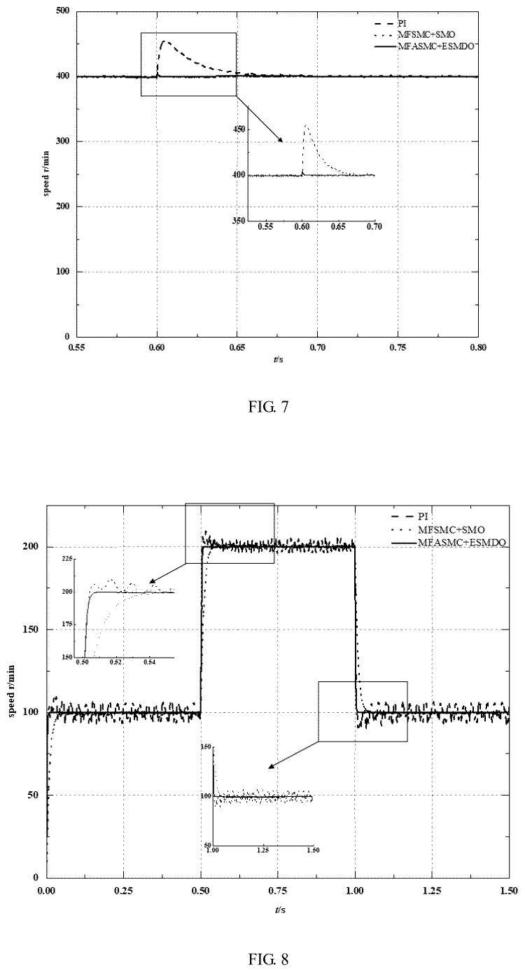

As can be observed from FIG. 5 and Table 3, during motor startup, the PI control exhibits significant overshoot, whereas the MFASMC+ESMDO and MFSMC+SMO methods show virtually no overshoot. Compared to both the PI control and the MFSMC+SMO method, the approach proposed in this application requires less time to reach a steady state, provides a faster response speed, and results in smaller speed fluctuations. FIGS. 6 and 7 respectively show the simulated speed response curves during sudden load application and sudden load removal. The control performance data for the three methods are provided in Table 4.

TABLE 4
Performance Comparison of the Three Control Methods
during Sudden Load Application and Removal

| | | MFSMC + | MFASMC + |
|---|---|---|---|
| Performance Indicators | PI | SMO | ESMDO |
| Overshoot during sudden | −55.296 | −10.004 | −7.434 |
| load increase (r/min) | | | |
| Maximum steady-state speed | 3.180 | 0.880 | 0.265 |
| fluctuation after sudden load | | | |
| increase (r/min) | | | |
| Overshoot during sudden | +54.247 | +9.213 | +4.281 |
| load decrease (r/min) | | | |
| Maximum steady-state speed | 2.071 | 0.615 | 0.325 |
| fluctuation after sudden load | | | |
| decrease(r/min) | | | |

When a load is applied at 0.4 s, the overshoot produced by MFASMC+ESMDO is reduced by 86.6% compared to PI control and by 25.7% compared to MFSMC+SMO. Furthermore, MFASMC+ESMDO requires only 0.0036 s to return to the given speed, whereas PI and MFSMC+SMO require 0.064 s and 0.026 s, respectively. Additionally, while PI control exhibits significant chattering, MFASMC+ESMDO demonstrates minimal chattering and a faster response speed compared to the other two algorithms.

When the load is removed at 0.6 s, the speed overshoot of MFASMC+ESMDO is reduced by 92.1% compared to PI control and by 53.5% compared to MFSMC+SMO. MFASMC+ESMDO requires only 0.002 s to reach a steady state, which represents a reduction of 96.9% compared to PI control and 66.7% compared to MFSMC+SMO. The speed fluctuations are also smaller compared to the other two control methods.

The above simulation results demonstrate that, compared to the other methods, MFASMC+ESMDO provides a faster response speed. During load variations, the speed not only returns to the set value more quickly but also exhibits smoother fluctuations, indicating stronger disturbance rejection capability and better robustness.

### Speed Variation Simulation:

The motor operates at a no-load speed of 100 r/min. At t=0.5 s, the speed reference is stepped to 200 r/min. After operating steadily for a period, the speed reference is changed back to 100 r/min at t=1.0 s. The speed response curves for the three control methods are shown in FIG. 8. Table 5 provides a performance comparison of these three control methods.

TABLE 5
Performance Comparison of the Three Control
Methods during Speed Variations

| | | MFSMC + | MFASMC + |
|---|---|---|---|
| Performance Indicators | PI | SMO | ESMDO |
| Overshoot during motor | 3.466 | 0 | 0 |
| startup(r/min) | | | |
| Maximum speed fluctuation | 13.984 | 2.011 | 0.150 |
| after stable startup(r/min) | | | |
| Overshoot during speed | 6.290 | 0.892 | 0 |
| acceleration (r/min) | | | |
| Maximum speed fluctuation | 9.524 | 1.052 | 0.421 |
| after stable | | | |
| acceleration(r/min) | | | |
| Overshoot during speed | −9.294 | −0.347 | 0 |
| deceleration (r/min) | | | |
| Maximum speed fluctuation | 14.395 | 1.633 | 0.545 |
| after stable | | | |
| deceleration(r/min) | | | |

As observed from FIG. 8 and Table 5, compared to the other two control methods, the MFASMC+ESMDO approach produces almost no speed overshoot throughout the entire operation and exhibits superior dynamic response characteristics. During the speed increase phase, MFASMC+ESMDO requires only 0.009 s to reach the target speed value, which is 73.4% faster than the PI control and 82% faster than the MFSMC+SMO method. In the speed reduction phase, both MFASMC+ESMDO and MFSMC+SMO generate significantly less overshoot than the PI control, and their speed fluctuations are also more stable. However, the response speed of MFSMC+SMO is considerably slower than that of MFASMC+ESMDO. The MFASMC+ESMDO method demonstrates superior overall performance.

### Forward/Reverse Rotation Simulation:

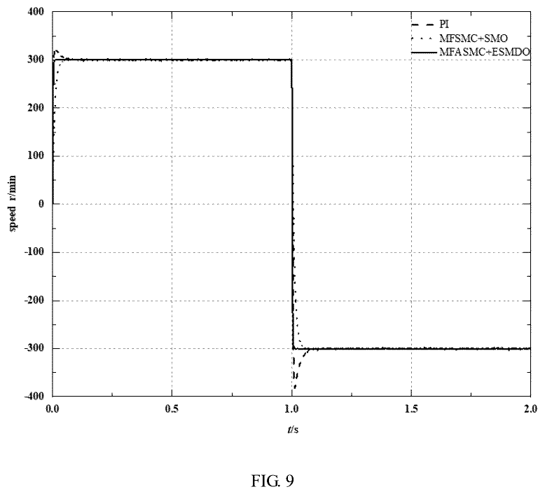

The total simulation time is set to 2 s. The initial speed is set to 300 r/min, and at t=1 s, the set speed is changed to −300 r/min. The simulated speed curves for the three control methods are shown in FIG. 9.

TABLE 6
Performance Comparison of the Three Control
Methods during forward and reverse rotation

| | | MFSMC + | MFASMC + |
|---|---|---|---|
| Performance Indicators | PI | SMO | ESMDO |
| Overshoot during forward | 21.851 | 0 | 0 |
| rotation(r/min) | | | |
| Maximum speed fluctuation | 4.199 | 0.779 | 0.244 |
| after stable forward | | | |
| rotation(r/min) | | | |
| Overshoot during reverse | −81.233 | 0 | 0 |
| rotation (r/min) | | | |
| Maximum speed fluctuation | 4.023 | 1.920 | 0.146 |
| after stable reverse | | | |
| rotation(r/min) | | | |

As can be seen from FIG. 9, whether during forward or reverse rotation, the speed overshoot generated by the PI control method is consistently significantly larger than that produced by the other two control methods, indicating lower motor stability. Furthermore, the transient process of MFASMC+ESMDO is smoother, and the time required to reach a steady state is considerably faster than both PI and MFSMC+SMO. Specifically, during forward motor rotation, its adjustment time is reduced by 85.7% compared to PI and by 80% compared to MFSMC+SMO. During reverse motor rotation, its adjustment time is reduced by 84.1% compared to PI and by 78.1% compared to MFSMC+SMO. According to Table 6, MFSMC+SMO does not exhibit excessive fluctuations throughout the entire operation and maintains high steady-state control accuracy.

To address the issue of Permanent Magnet Synchronous Motor (PMSM) control systems being susceptible to uncertainties such as load disturbances, this application takes a Surface-mounted PMSM (SPMSM) as the control object. Based on model-free control theory and adaptive sliding mode algorithms, it constructs a model-free adaptive sliding mode controller. Furthermore, an Extended Sliding Mode Disturbance Observer (ESMDO) is constructed to accurately observe, in real-time, the system parameter uncertainties and unknown disturbances denoted as F. This observed value is used for feedforward compensation of the model-free adaptive sliding mode controller, thereby enhancing the precision of motor control. Simulation results demonstrate that the method proposed in this application offers superior dynamic performance, stronger disturbance rejection capability, and can effectively improve the robustness of the motor system.

Based on the ultra-local model of the motor, an integral-differential sliding mode surface is constructed to reduce the steady-state error of the system. Meanwhile, an adaptive factor η is introduced to achieve the rapid convergence of the system. The constructed model-free sliding mode controller with adaptive switching gain is used as the speed loop feedback controller, which reduces the chattering of the motor system and improves the robustness of the system.

Based on the ultra-local model, an extended sliding mode disturbance observer is constructed to achieve precise observation of the system. Compared with ordinary sliding mode observers, it can effectively reduce system chattering and improve control accuracy.

The disclosure combines the extended sliding mode disturbance observer and the model-free adaptive sliding mode control and applies them to the motor speed loop, and through comprehensive simulation comparison with the traditional PI control method and model-free sliding mode control method in the aspects of motor loading/unloading, speed up/down and forward/reverse rotation and the like, the simulation results demonstrate that the method of the disclosure has strong anti-interference capability and robustness, along with better tracking performance and faster dynamic response.

The embodiments described above are merely preferred examples provided to fully illustrate the present disclosure, and the scope of protection is not limited thereto. Any equivalent replacements or modifications made by persons skilled in the art based on the present disclosure shall fall within the protection scope of the present disclosure.

What is claimed is:

1. A control method based on ESMDO and model-free adaptive sliding mode, comprising:
establishing a Surface-mounted Permanent Magnet Synchronous Motor mathematical model to obtain a state equation of speed loop;
constructing a model-free adaptive sliding mode controller, which further comprising: first establishing an ultra-local model for a single-input single-output nonlinear system, and introducing the state equation of the speed loop to obtain an extended ultra-local model of SPMSM speed loop;
based on model-free control theory and integrating the extended ultra-local model of the SPMSM speed loop, constructing an integral-derivative sliding mode surface and a model-free adaptive sliding mode control law for the speed loop; and
constructing an Extended Sliding Mode Disturbance Observer, which further comprising: establishing a disturbance observer model and constructing a sliding mode control law for the observer based on the extended ultra-local model of the SPMSM speed loop;
the model-free adaptive sliding mode controller outputs a reference current to a motor module based on an input reference speed, the motor module outputs an actual current and actual speed, the Extended Sliding Mode Disturbance Observer observes the actual speed, system parametric uncertainties and unknown disturbances, and outputs the actual speed, the system parametric uncertainties and unknown disturbances, the system parametric uncertainties and unknown disturbances are subsequently fed back into the model-free adaptive sliding mode controller, the actual speed is utilized for feedforward compensation of the reference speed, thereby controlling the motor module.

2. The control method based on ESMDO and model-free adaptive sliding mode according to claim 1, wherein in establishing the SPMSM mathematical model, the core saturation effects are ignored, the eddy current and hysteresis losses are ignored, and internal parameter perturbation and load disturbance are introduced to obtain the motor's torque equation and mechanical motion equation, and the state equation of the speed loop is obtained based on the torque equation and mechanical motion equation.

3. The control method based on ESMDO and model-free adaptive sliding mode according to claim 1, wherein the torque equation of the motor is:
$${T}_{e} = \frac{3}{2} {n}_{p} {i}_{q} {ψ}_{f} + Δ {T}_{e} ,$$
where Tₑ is the electromagnetic torque, i_{q} is the q-axis stator current component, nₚ is the number of pole pairs, ψ_{f} is the permanent magnet flux linkage, and ΔTₑ is the variation of the electromagnetic torque,
the mechanical motion equation of the motor is:
$$\frac{d {ω}_{e}}{dt} = \frac{{n}_{p}}{J} ( {T}_{e} - {T}_{L} - B {ω}_{m} ) + Δ {P}_{n} ,$$
Where T_{L} is the load torque, B is the viscous friction coefficient, ωₘ is the mechanical angular velocity, ωₑ is the electrical angular velocity, ΔPₙ is the disturbance variable caused by variations in the moment of inertia and viscous friction coefficient,
$$\frac{d {ω}_{e}}{dt}$$
represents the differential of the electrical angular velocity, and J is the moment of inertia,
the state equation of the motor's speed loop is:
$$\frac{d {ω}_{e}}{dt} = \frac{3}{2} \frac{{n}_{p}^{2}}{J} {ψ}_{f} - \frac{B}{J} {ω}_{e} + \frac{{n}_{p}}{J} ( Δ {T}_{e} - {T}_{L} + Δ {T}_{L} ) + Δ {P}_{n} ,$$
where ΔT_{L} is the unknown disturbance caused by variations of the load torque.

4. The control method based on ESMDO and model-free adaptive sliding mode according to claim 1, wherein the ultra-local model of the nonlinear system is:
$$\{ \begin{matrix}\dot{x} = {α}_{1} u + {β}_{1} x + {F}_{1} \\ y = x\end{matrix} ,$$
where α₁ is a design parameter to be determined, β₁ is the state gain of the system, F₁ is a nonlinear bounded function satisfying the Lebesgue measurability theorem, u is the system input variable, and χ is the input variable of nonlinear system.

5. The control method based on ESMDO and model-free adaptive sliding mode according to claim 1, wherein the extended ultra-local model of the SPMSM speed loop is:
$$\{ \begin{matrix}\frac{d {ω}_{e}}{dt} = α {i}_{q} + {βω}_{e} + F \\ \frac{dF}{dt} = ξ ( t )\end{matrix} ,$$
Where α is the q-axis current gain to be determined, β is the speed gain to be determined, F is system parametric uncertainties and unknown disturbances, ξ(t) is the rate of change of F and i_{q} is the q-axis stator current component.

6. The control method based on ESMDO and model-free adaptive sliding mode according to claim 1, wherein an integral differential sliding mode surface is: s=x₁+c∫x₁+m\dot{x}₁, where x₁ is the speed error, both c and m are constants greater than zero.

7. The control method based on ESMDO and model-free adaptive sliding mode according to claim 6, wherein an adaptive exponential reaching law is constructed based on the integral differential sliding mode surface, and the said adaptive exponential reaching law is:
$$\{ \begin{matrix}\dot{s} = - ηsigmoid ( s ) - ks \\ \dot{\hat{η}} = \vert s \vert\end{matrix} ,$$
where
$$sigmoid ( x ) = \frac{2}{1 + {e}^{- ax}} - 1 ,$$
α>0, η is an adaptive factor, and k is an arbitrary positive real number.

8. The control method based on ESMDO and model-free adaptive sliding mode according to claim 7, wherein a model-free adaptive sliding mode control law for the speed loop is:
$${i}_{q}^{*} = \frac{\begin{matrix}- \hat{F} - {βω}_{e} + {\dot{ω}}_{e}^{*} + ks + \\ \hat{η} sigmoid ( s ) + c ( {ω}_{e}^{*} - {ω}_{e} ) + m ( {\ddot{ω}}_{e}^{*} - {\ddot{ω}}_{e} )\end{matrix}}{α} ,$$
where \hat{F} is the online estimation of F using the Extended Sliding Mode Disturbance Observer,
$${ω}_{e}^{*}$$
is the reference speed of motor, ωₑ is the electrical angular velocity, and a is a q-axis current coefficient to be determined.

9. The control method based on ESMDO and model-free adaptive sliding mode according to claim 1, wherein the disturbance observer model is:
$$\{ \begin{matrix}\frac{d {\hat{ω}}_{e}}{dt} = α {i}_{q} + β {\hat{ω}}_{e} + \hat{F} + {u}_{ESMDO} \\ \frac{d \hat{F}}{dt} = χ \cdot {u}_{ESMDO}\end{matrix} ,$$
Where \hat{ω}ₑ is the observed value of speed, \hat{F} is the observed value of system parameter uncertainties and unknown disturbances; d\hat{F}/dt is the rate of change of \hat{F}; χ is the gain of the disturbance observer, and u_{ESMDO} is the observer sliding mode control law.

10. The control method based on ESMDO and model-free adaptive sliding mode according to claim 9, wherein an error equation is obtained based on the disturbance observer model and the SPMSM speed loop extended ultra-local model, as follows:
$$\{ \begin{matrix}{\dot{e}}_{s} = β {e}_{s} + {e}_{f} + {u}_{ESMDO} \\ {\dot{e}}_{f} = χ \cdot {u}_{ESMDO} - ξ ( t )\end{matrix} ,$$
where eₛ is the speed observation error, defined as eₛ=\hat{ω}ₑ−ωₑ, e_{f} is the observation error of F, defined as e_{f}=\hat{F}−F,
the observer sliding mode surface is constructed as: s_{ω}=eₛ=\hat{ω}ₑ−ωₑ,
the observer exponential reaching law is constructed as: \dot{s}_{ω}=−ε_{ω} sgn(eₛ)−k_{ω}eₛ, where ε_{ω} is a switch gain to be constructed, k_{ω} is an exponential term coefficient to be constructed, and both ε_{ω} and k_{ω} are greater than zero,
based on the error equation and the observer exponential reaching law, the observer sliding mode control law u_{ESMDO} is obtained as:
u_{ESMDO}=−ε_{ω}sigmoid(eₛ)−k_{ω}eₛ−βeₛ.
